(19) United States
(12) Patent Application Publication
(10) Pub. No.: US 2025/0332918 A1
(43) Pub. Date: Oct. 30, 2025

(54) DEFORMABLE SCREEN AND CONTROL SYSTEM

(71) Applicant: AUO Corporation, Hsinchu City (TW)

(72) Inventors: Yu-Chi Chen, Hsinchu City (TW); Chi-Yu Liu, Hsinchu City (TW); Chia-Sheng Cheng, Hsinchu City (TW)

(73) Assignee: AUO Corporation, Hsinchu City (TW)

(21) Appl. No.: 19/091,871

(22) Filed: Mar. 27, 2025

(30) Foreign Application Priority Data
Apr. 25, 2024 (TW) 113115347

(51) Int. Cl. B60K 35/22; G06F 3/044; G06F 3/16; G06V 20/59; G06V 40/10; G06V 40/20

(52) U.S. Cl. CPC B60K 35/223; G06F 3/0443; G06F 3/0446; G06F 3/0447; G06F 3/167; G06V 20/59; G06V 40/10; G06V 40/28; B60K 2360/11; B60K 2360/1438; B60K 2360/146; B60K 2360/148

(57) ABSTRACT

A control system including a processing unit and a control device is provided. The control device is connected to the processing unit and includes a deformable screen. The deformable screen displays at least one graphical interface and shows a plurality of deformation states according to a plurality of control information provided by the processing unit, wherein the plurality of deformation states are different from each other.

### CROSS-REFERENCE TO RELATED APPLICATION

This application claims the priority benefit of Taiwan application serial no. 113115347, filed on Apr. 25, 2024. The entirety of the above-mentioned patent application is hereby incorporated by reference herein and made a part of this specification.

### BACKGROUND

### Technical Field

The disclosure relates to a deformable screen and a control system.

### Description of Related Art

Traditional electronic devices are mostly operated by buttons and knobs. However, these buttons and knobs are prone to dust accumulation, which is aesthetically unpleasing and occupies space.

### SUMMARY

The disclosure provides a control system that utilizes a deformable screen to provide the graphical interfaces, replacing traditional buttons and knobs, which is practical and aesthetically pleasing.

According to an embodiment of the disclosure, a control system is provided, including a processing unit and a control device. The control device is connected to the processing unit and includes a deformable screen. The deformable screen displays at least one first graphical interface and shows a plurality of deformation states according to a plurality of control information provided by the processing unit, wherein the plurality of deformation states are different from each other.

According to an embodiment of the disclosure, a deformable screen is provided. The deformable screen displays at least one first graphical interface and shows a plurality of deformation states according to a plurality of control information, and the plurality of deformation states are different from each other.

Based on the foregoing, the control system provided by the embodiment of the disclosure utilizes the deformable screen to provide the graphical interfaces, replacing traditional buttons and knobs. The deformable screen has the plurality of deformation states, making operation more convenient, practical, and aesthetically pleasing.

In order to make the above-mentioned features and advantages of the disclosure clearer and easier to understand, the following embodiments are given and described in details with accompanying drawings as follows.

### BRIEF DESCRIPTION OF THE DRAWINGS

FIG. 1 is a block diagram of a control system according to some embodiments of the disclosure.

FIG. 2A and FIG. 3A are top view diagrams of deformation diagrams of a deformable screen according to embodiments of the disclosure.

FIG. 2B and FIG. 3B are partial three-dimensional schematic diagrams of the deformable screen corresponding to FIG. 2A and FIG. 3A.

FIG. 4 is a block diagram of a control system according to some embodiments of the disclosure.

FIG. 5 is a schematic diagram of a control device according to some embodiments of the disclosure.

FIG. 6A is a block diagram of a control system according to some embodiments of the disclosure.

FIG. 6B and FIG. 6C are schematic diagrams of the front display and the deformable screen in FIG. 6A.

### DESCRIPTION OF THE EMBODIMENTS

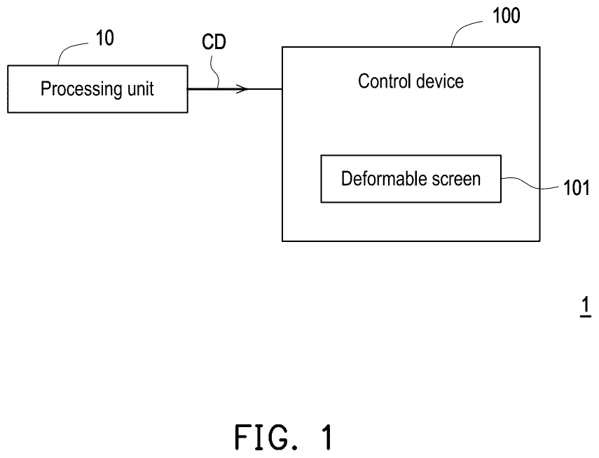

Referring to FIG. 1, FIG. 1 is a block diagram of a control system 1 according to some embodiments of the disclosure. The control system 1 includes a processing unit 10 and a control device 100. The control device 100 is connected to the processing unit 10 and includes a deformable screen 101. The deformable screen 101 shows a plurality of deformation states according to a plurality of control information CD provided by the processing unit 10, wherein the plurality of deformation states are different from each other. The processing unit 10 may be, for example, a central processing unit (CPU), a microprocessor, a digital signal processor (DSP), a programmable controller, a programmable logic device (PLD), or other similar devices, or a combination thereof, and the disclosure is not limited thereto.

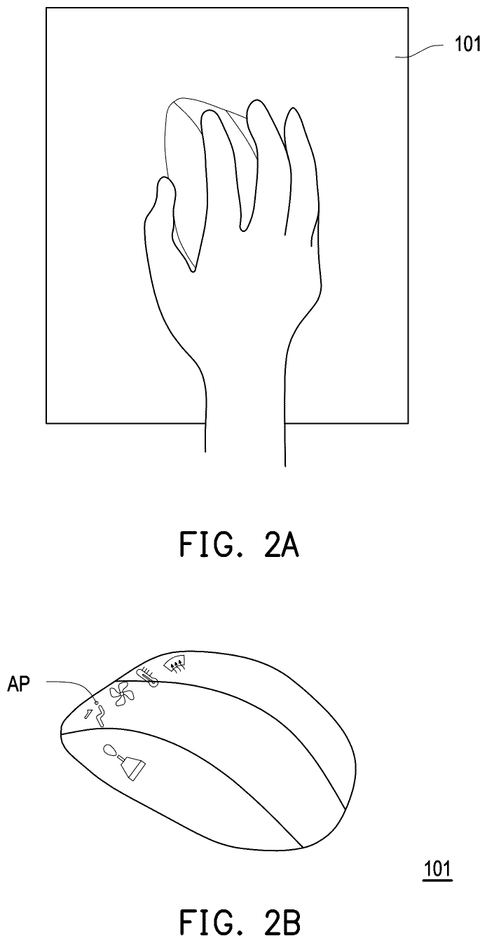

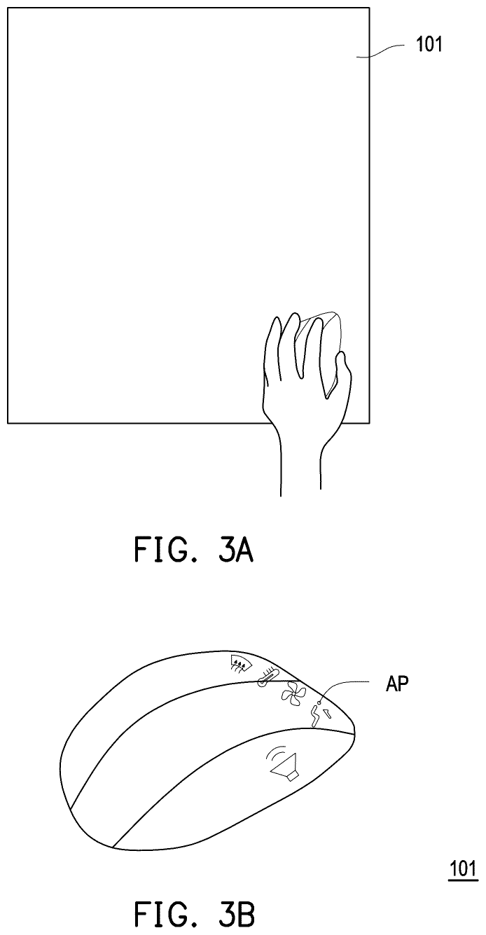

Specifically, referring to FIG. 2A, FIG. 2B, FIG. 3A, and FIG. 3B, FIG. 2A and FIG. 3A are top view diagrams of deformation diagrams of a deformable screen according to embodiments of the disclosure. FIG. 2B and FIG. 3B are partial three-dimensional schematic diagrams of the deformable screen corresponding to FIG. 2A and FIG. 3A.

In this embodiment, corresponding to one control information CD provided by the processing unit 10, the deformable screen 101 shows a deformation state protruding upward at its central part as shown in FIG. 2A. Corresponding to another control information CD provided by the processing unit 10, the deformable screen 101 shows a deformation state protruding upward at its lower right corner part as shown in FIG. 3A. Conversely, when the processing unit 10 does not provide the control information CD, the deformable screen 101 may return to a flat state without any protruding parts. It should be noted that the deformable screen 101 of the embodiment of the disclosure may show a plurality of deformation states different from each other, not limited to the deformation states shown in FIG. 2A, FIG. 2B, FIG. 3A, and FIG. 3B.

In some embodiments, the control system 1 may be implemented as an automotive control system, wherein the deformable screen 101 may be disposed in a position between the driver's seat and the adjacent passenger's seat. For example, FIG. 2A and FIG. 2B may illustrate the deformable screen 101 when operated by a left-hand drive driver, while FIG. 3A and FIG. 3B may illustrate the deformable screen 101 when operated by a passenger to the right of the driver. A plurality of graphical interfaces AP are displayed at positions corresponding to the user's fingers for finger-press selection. However, the disclosure is not limited thereto. In other embodiments, the control system 1 may be implemented in environments other than the vehicle interior, such as indoor environments.

In some embodiments, the deformable screen 101 includes a plurality of touch electrodes, allowing the user to deform the deformable screen 101 by touching it. Specifically, when the processing unit 10 does not provide the control information CD (the deformable screen 101 is not deformed), the user's hand may touch the deformable screen 101, causing these touch electrodes to generate touch information due to the touch. The processing unit connected to the deformable screen 101 then generates the corresponding control information CD based on this touch information, and the deformable screen 101 further deforms according to the user's gesture, forming a shape that adapts to the user's gesture. For example, when the user places his or her hand on the flat deformable screen 101 as shown in FIG. 2A, the touch electrodes of the deformable screen 101 generate touch information. The processing unit then generates the corresponding control information CD based on this touch information, causing the deformable screen 101 to deform and show an upward protruding deformation state as shown in FIG. 2A and FIG. 2B. Similarly, if the user places his or her hand on the flat deformable screen 101 as shown in FIG. 3A, the touch electrodes of the deformable screen 101 generate touch information. The processing unit then generates the corresponding control information CD based on this touch information, causing the deformable screen 101 to deform and show an upward protruding deformation state as shown in FIG. 3A and FIG. 3B.

To fully describe various implementation aspects of the disclosure, other embodiments of the disclosure are described in the following. It must be noted here that the following embodiments use the element numerals and part of the contents of the foregoing embodiments. The same numerals are used to denote the same or similar elements, and the description of the same technical content is omitted. For the description of the omitted parts, reference may be made to the foregoing embodiments, and thus the description is not repeated in the following embodiments.

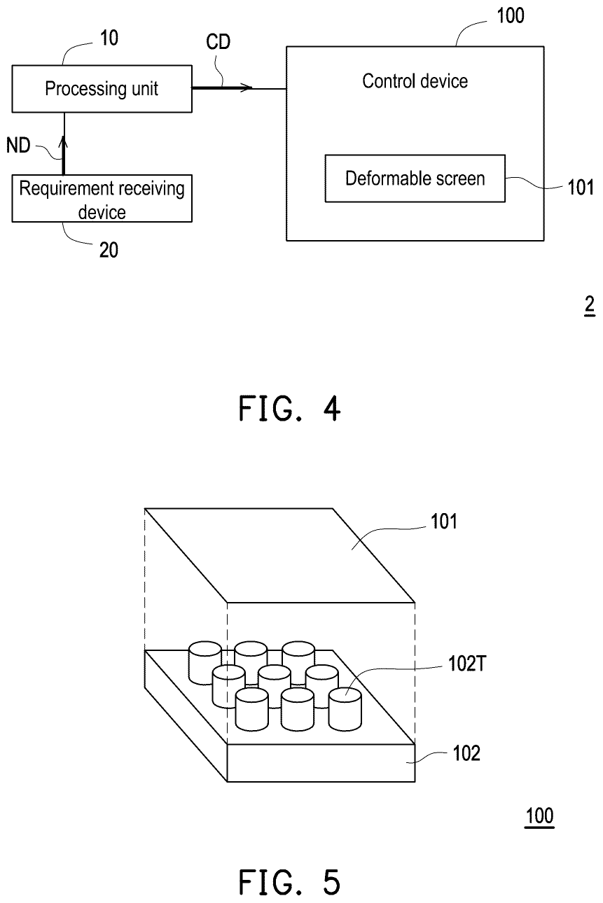

Referring to FIG. 4, FIG. 4 is a block diagram of a control system 2 according to some embodiments of the disclosure. The control system 2 includes the processing unit 10, a requirement receiving device 20, and the control device 100. The requirement receiving device 20 is connected to the processing unit 10, and the processing unit 10 generates the control information CD based on requirement information ND provided by the requirement receiving device 20. The control device 100 is connected to the processing unit 10 and includes the deformable screen 101. The deformable screen 101 deforms according to the control information CD provided by the processing unit 10.

In an embodiment, the requirement receiving device 20 may be a camera, the requirement information ND may be image information, and the processing unit 10 may include a gesture detection algorithm. The processing unit 10 may utilize the gesture detection algorithm and the image information generated by the camera to generate the control information CD. Specifically, a camera may be utilized to capture an image of the user, and generate the corresponding control information CD based on the user's actions. For example, in an embodiment, the control system 2 may be implemented as an automotive control system. The deformable screen 101 may be disposed in a position between the driver's seat and the adjacent passenger's seat, and the requirement receiving device 20 may be a camera used to capture an image of the people inside the vehicle. When the driver's hand extends towards the deformable screen 101, the camera may instantly generate image information corresponding to the driver's image. The gesture detection algorithm of the processing unit 10 may then analyze this image information, thereby allowing the processing unit 10 to generate the corresponding control information CD, and causing the deformable screen 101 to deform and show an upward protruding deformation state as shown in FIG. 2A and FIG. 2B. Similarly, when the hand of the passenger to the right of the driver extends towards the deformable screen 101, the camera may instantly generate image information corresponding to that passenger's image. The gesture detection algorithm of the processing unit 10 may then analyze this image information, thereby allowing the processing unit 10 to generate the corresponding control information CD, and causing the deformable screen 101 to deform and show an upward protruding deformation state as shown in FIG. 3A and FIG. 3B.

In an embodiment, the requirement receiving device 20 may be a microphone, the requirement information ND may be audio information, and the processing unit 10 may include a voice control algorithm. The processing unit 10 may utilize the voice control algorithm and the audio information generated by the microphone to generate the control information CD. Specifically, the user may utilize the microphone to voice control the control system 2, causing the processing unit 10 to generate the corresponding control information CD. For example, in an embodiment, the control system 2 may be implemented as an automotive control system. The deformable screen 101 may be disposed in a position between the driver's seat and the adjacent passenger's seat, and the requirement receiving device 20 may be a microphone. When the driver issues a control request via the microphone, the microphone may instantly generate audio information corresponding to the driver's control request. The voice control algorithm of the processing unit 10 may then analyze this audio information, thereby allowing the processing unit 10 to generate the corresponding control information CD, and causing the deformable screen 101 to deform and show an upward protruding deformation state as shown in FIG. 2A and FIG. 2B. Similarly, when the passenger to the right of the driver issues a control request via the microphone, the microphone may instantly generate audio information corresponding to that passenger's control request. The voice control algorithm of the processing unit 10 may then analyze this audio information, thereby allowing the processing unit 10 to generate the corresponding control information CD, and causing the deformable screen 101 to deform and show an upward protruding deformation state as shown in FIG. 3A and FIG. 3B.

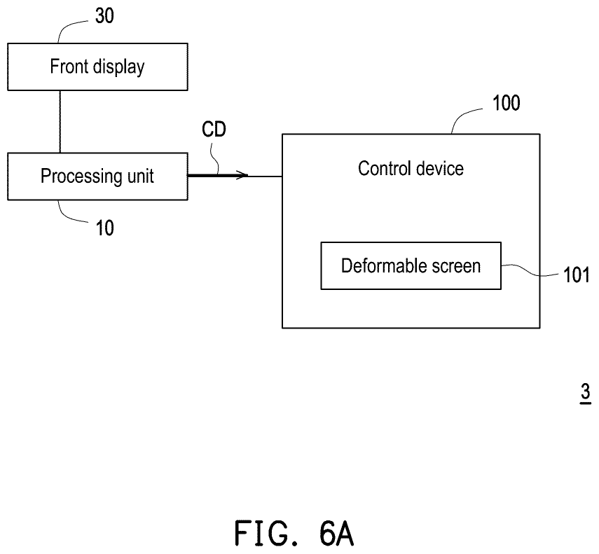

Referring to FIG. 5, FIG. 5 is a schematic diagram of a control device according to some embodiments of the disclosure. The control device 100 includes the deformable screen 101 and a columnar lifting mechanism 102. The columnar lifting mechanism 102 includes a plurality of columns 102T. Each column 102T may independently rise and fall. Accordingly, the deformable screen 101 configured above the columnar lifting mechanism 102 may show a plurality of deformation states. However, the disclosure is not limited thereto. In other embodiments, the shape of the deformable screen 101 may be changed by different methods.

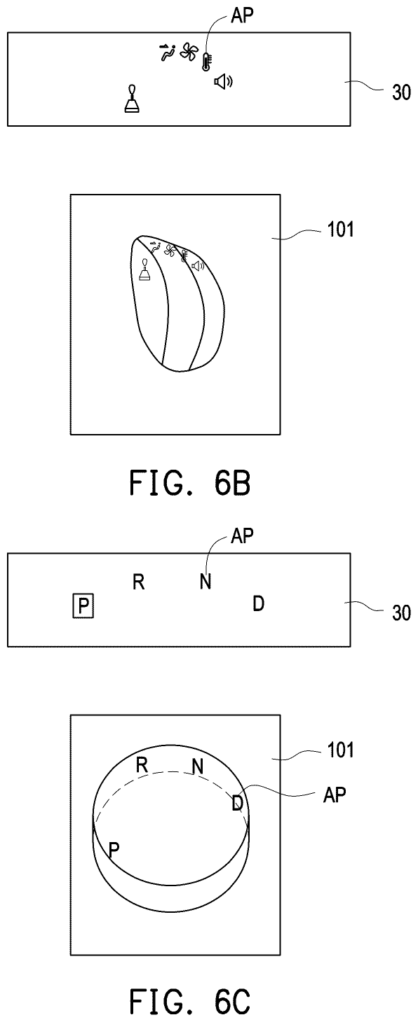

Referring to FIG. 6A, FIG. 6B and FIG. 6C, FIG. 6A is a block diagram of a control system according to some embodiments of the disclosure, and FIG. 6B and FIG. 6C are schematic diagrams of the front display and the deformable screen in FIG. 6A.

In this embodiment, a control system 3 includes the processing unit 10, a front display 30, and the control device 100. The control device 100 is connected to the processing unit 10 and includes the deformable screen 101. The deformable screen 101 deforms according to the control information CD provided by the processing unit 10. The front display 30 is connected to the processing unit 10. As shown in FIG. 6B and FIG. 6C, the deformable screen 101 displays the plurality of graphical interfaces AP, and the front display 30 displays the same plurality of graphical interfaces AP. Accordingly, the driver does not need to look down to check the graphical interfaces AP on the deformable screen 101, but only needs to select the required function via the deformable screen 101 according to the plurality of graphical interfaces AP displayed on the front display 30, thereby improving driving safety.

In some embodiments, the deformation state of the deformable screen 101 may adapt to the user's gesture. As shown in FIG. 2A, FIG. 3A, and FIG. 6B, it is suitable for the user to select a function by pressing any graphical interface AP. In some embodiments, the deformation state of the deformable screen 101 may include a circular protrusion, as shown in FIG. 6C, which is suitable for the user to switch between different graphical interfaces AP by sliding.

In summary, the control system provided by the embodiments of the disclosure utilizes the deformable screen to provide the graphical interfaces, replacing traditional buttons and knobs. The deformable screen has the plurality of deformation states, making operation more convenient, practical, and aesthetically pleasing.

What is claimed is:

1. A control system, comprising:
a processing unit; and
a control device, connected to the processing unit, and comprising a deformable screen, wherein the deformable screen displays at least one first graphical interface and shows a plurality of deformation states according to a plurality of control information provided by the processing unit, and the plurality of deformation states are different from each other.

2. The control system according to claim 1, further comprising a requirement receiving device, connected to the processing unit, wherein the processing unit generates the control information according to requirement information provided by the requirement receiving device.

3. The control system according to claim 2, wherein the requirement receiving device is a camera, the requirement information is image information, the processing unit comprises a gesture detection algorithm, and the processing unit utilizes the gesture detection algorithm and the image information generated by the camera to generate the control information.

4. The control system according to claim 2, wherein the requirement receiving device is a microphone, the requirement information is audio information, the processing unit comprises a voice control algorithm, and the processing unit utilizes the voice control algorithm and the audio information generated by the microphone to generate the control information.

5. The control system according to claim 1, wherein the deformable screen comprises a plurality of touch electrodes, and the processing unit generates the control information according to touch information generated by the plurality of touch electrodes.

6. The control system according to claim 1, wherein the control device further comprises a columnar lifting mechanism, the columnar lifting mechanism is configured under the deformable screen and comprises a plurality of columns, and each column is independently controlled to rise and fall.

7. The control system according to claim 1, wherein the control system is an automotive control system.

8. The control system according to claim 7, wherein the deformable screen is disposed in a position between a driver's seat and an adjacent passenger's seat.

9. The control system according to claim 7, further comprising a front display, connected to the processing unit, wherein the front display is adapted to display at least one second graphical interface corresponding to the at least one first graphical interface.

10. The control system according to claim 9, wherein the at least one first graphical interface is adapted to be selected by pressing or switched by sliding.

11. The control system according to claim 1, wherein the plurality of deformation states are adapted to a user's gesture.

12. The control system according to claim 1, wherein the plurality of deformation states comprise a circular protrusion.

13. The control system according to claim 1, wherein when the deformable screen shows one of the plurality of deformation states, a portion of the deformable screen is flat, and another portion of the deformable screen is a protrusion.

14. The control system according to claim 1, wherein the at least one first graphical interface is displayed on a portion of the deformable screen, and a position of the portion corresponds to at least one finger of a user for selection by pressing the at least one first graphical interface with the at least one finger.

15. The control system according to claim 1, wherein the deformable screen comprises a plurality of touch electrodes, and the touch electrodes allow a user to deform the deformable screen by touching the deformable screen.

16. The control system according to claim 5, wherein the plurality of deformation states include a protrusion.

17. A deformable screen, wherein the deformable screen displays at least one first graphical interface and shows a plurality of deformation states according to a plurality of control information, and the plurality of deformation states are different from each other.

18. The deformable screen according to claim 17, comprising a plurality of touch electrodes, the plurality of touch electrodes are used to provide touch information, wherein the touch information corresponds to the plurality of control information.

19. The deformable screen according to claim 17, wherein the at least one first graphical interface is adapted to be selected by pressing or switched by sliding.

20. The deformable screen according to claim 17, wherein the plurality of deformation states are adapted to a user's gesture.
